(19) United States
(12) Patent Application Publication
(10) Pub. No.: US 2025/0005355 A1
(43) Pub. Date: Jan. 2, 2025

(54) Decentralised Qubo Solver and Cryptocurrency Generation

(71) Applicant: Mastercard International Incorporated, New York, NY (US)

(72) Inventor: Nicola MARIELLA, Oranmore (IE)

(21) Appl. No.: 18/707,552

(22) PCT Filed: Oct. 31, 2022
(86) PCT No.: PCT/US2022/048360

§ 371 Date: May 3, 2024

(30) Foreign Application Priority Data
Nov. 4, 2021 (GB) 2115877.9

(51) Int. Cl. G06N 3/08; G06F 16/27

(52) U.S. Cl. CPC G06N 3/08; G06F 16/27

(57) ABSTRACT

A routing optimization computer implemented method is provided, comprising: determining a non-convex sub-problem and a convex sub-problem of a constrained optimization problem; generating a smart contract corresponding to the non-convex sub-problem; transmitting the smart contract to a distributed ledger; broadcasting the smart contract to a plurality of solvers; receiving a first binary solution to the non-convex sub-problem from a first solver; receiving a further binary solution to the non-convex sub-problem from a second solver; determining a more suitable solution of the first binary solution and the further binary solution; transmitting a payment associated with the smart contract; transmitting the more suitable binary solution; determining a time solution to the convex sub-problem using the more suitable binary solution; repeating steps using the time solution as the continuous variable, until a threshold is met; and mapping the binary solution and the time solution to the constrained optimization problem.

### CROSS REFERENCE TO RELATED APPLICATION

This application claims the benefit of United Kingdom Patent Application No. 2115877.9, which was filed on Nov. 4, 2021, the entire contents of which are hereby incorporated by reference for all purposes.

### TECHNICAL FIELD

The present disclosure relates to quantum computing. In particular, the present disclosure relates to a computer-implemented method and corresponding computing device for determining optimal vehicle routes and generating cryptocurrency tokens.

### BACKGROUND

Quantum computers exploit the quantum superposition characteristics of particles to determine the optimal solution to complex non-linear problems. Unlike classical computers where a classical memory bit will take either a value of “1” or a value of “0”; in a quantum computer, a quantum bit or “qubit” may take a value of “1”, “0” or a superposition of “1” and “0”. By resolving the value of a plurality of qubits, the quantum computer can determine the minimum energy state of the qubits and so determine in one computation cycle the optimum solution to a given problem.

In order to exploit the processing efficiency of a quantum computer to solve a complex real world problem, the real world problem and variable may need to be expressed to the quantum computer in a resolvable manner. Determining how to express the problem and variables may be a computationally expensive or complex task which may require more processing cycles than would be needed to solve the problem using a traditional iterative method.

Bitcoin is a type of decentralised digital currency used in peer-to-peer transactions. Transactions are verified by network nodes through cryptography and recorded in a public distributed ledger called a Blockchain. Bitcoins are generated as reward for a process often known as bitcoin mining. To be accepted by the rest of the network, a new block of the Blockchain must contain a proof-of-work, where nodes compete to be the first node to find a solution to a hashing problem. FIG. 4 depicts a known Bitcoin generation method.

Finding a solution to the hashing problem is computationally expensive, and Bitcoin mining is therefore energy intensive. The energy, such as electricity, required to solve the hashing problem is high. Therefore, Bitcoin mining can be considered detrimental to the environment. Additionally, the solutions to the hashing problem itself serve no purpose other than to secure the Blockchain network.

The present disclosure has been devised to mitigate or overcome at least some of the above-mentioned problems.

### SUMMARY OF THE DISCLOSURE

In accordance with a first aspect of the present invention a non-convex sub-problem solving method comprising the steps: determining, by a classical computer, the non-convex sub-problem based on a constrained optimization problem; generating, by the classical computer, a smart contract corresponding to the non-convex sub-problem; transmitting, by the classical computer, the smart contract to a distributed ledger; broadcasting, by the distributed ledger, the smart contract to a plurality of solvers; receiving, at the distributed ledger, a first solution to the non-convex sub-problem from a first solver; receiving, at the distributed ledger, a further solution to the non-convex sub-problem from a second solver; determining, by a decision mechanism of the distributed ledger, the solution of the first solution and the further solution that is more suitable; transmitting, by the distributed ledger to the solver of the more suitable solution, a payment associated with the smart contract; transmitting, by the distributed ledger to the classical computer, the more suitable solution.

Preferably, the non-convex sub-problem is a quadratic unconstrained binary optimization (QUBO) sub-problem.

Preferably, the first and further solutions are each binary strings.

Preferably, the suitability of a solution is dependent on an energy of the solution.

Preferably, the more suitable solution is the solution providing the lowest energy.

Preferably, determining the energy of the solution of a QUBO sub-problem comprises applying the solution to the QUBO sub-problem, thereby producing an energy scalar.

Preferably, the suitability of the solution is further dependent on a time of arrival of the solution.

In accordance with a second aspect of the present invention, there is provided a routing optimization computer implemented method comprising the steps: (a) determining, by the classical computer, a non-convex sub-problem and a convex sub-problem of a constrained optimization problem, the constrained optimization problem comprising: a binary variable indicative of a vehicle visiting a plurality of nodes; and a continuous variable representative of a time at which the vehicle arrives at each of the plurality of nodes; wherein the continuous variable is fixed for the non-convex sub-problem and the binary variable is fixed for the convex sub-problem; (b) generating, by the classical computer, a smart contract corresponding to the non-convex sub-problem; (c) transmitting, by the classical computer, the smart contract to a distributed ledger; (d) broadcasting, by the distributed ledger, the smart contract to a plurality of solvers; (e) receiving, at the distributed ledger, a first binary solution to the non-convex sub-problem from a first solver; (f) receiving, at the distributed ledger, a further binary solution to the non-convex sub-problem from a second solver; (g) determining, by a decision mechanism of the distributed ledger, a more suitable solution of the first binary solution and the further binary solution; (h) transmitting, by the distributed ledger to the solver of the more suitable binary solution, a payment associated with the smart contract; (i) transmitting, by the distributed ledger to the classical computer, the more suitable binary solution; (j) determining, by the classical computer, a time solution to the convex sub-problem using the more suitable binary solution as the binary variable; (k) repeating steps (b) to (c), using the time solution as the continuous variable, until a threshold is met; and (l) mapping the binary solution and the time solution to the constrained optimization problem, thereby providing an optimized routing.

Preferably, the non-convex sub-problem is a quadratic unconstrained binary optimization (QUBO) sub-problem.

Preferably, the constrained optimization problem is solved according to an alternating direction method of multipliers (ADMM) method.

Preferably, the time solution is determined according to a sequential convex programming method.

Preferably, the method further comprises determining the constrained optimization based on a set of routing details, wherein the constrained optimization problem comprises a plurality of constraints.

Preferably, the plurality of constraints comprises: a distribution constraint; a sequence constraint; an allowable route constraint; an end constraint; a starting node constraint; a finishing node constraint; a time window constraint; a time of arrival constraint; and a finishing time constraint.

Preferably the threshold is an iteration threshold.

Preferably, the threshold is a solution plateau threshold.

Preferably, the suitability of a solution is dependent on an energy of the solution; and optionally a time of arrival of the solution.

Preferably, determining the energy of the solution of a QUBO sub-problem comprises applying the solution to the QUBO sub-problem, thereby producing an energy scalar.

Preferably, the distributed ledger is a blockchain.

### BRIEF DESCRIPTION OF THE DRAWINGS

One or more embodiments of the disclosure will now be described, by way of example only, with reference to the accompanying drawings, in which:

FIG. 1 is a computing system;

FIG. 2 is a method for optimizing vehicle routes using the computing system of FIG. 1;

FIG. 3 is a method for generating a cryptocurrency token using the computing system of FIG. 1; and

FIG. 4 is a known Bitcoin generation method.

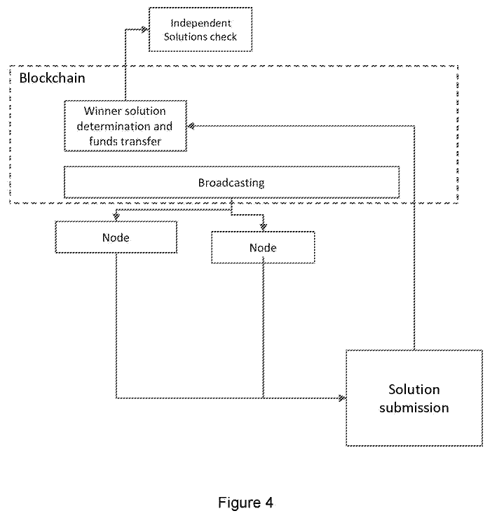

### DETAILED DESCRIPTION

### Quadratic Unconstrained Binary Optimisation

A real world problem may be formulated as an objective optimisation problem subject to a number of constraints. The objective optimisation problem may be a combinatorial problem that fits the QUBO (Quadratic Unconstrained Binary Optimisation) form. A QUBO problem is a form of discrete optimisation problems that involves finding a set x of N binary variables {xᵢ} that minimises the objective problem, defined as:

$$E ( x ) = {x}^{T} Q x$$

Where Q is an N×N matrix comprising elements qᵢⱼ that is characteristic of the real world problem, wherein elements qᵢⱼ preferably represent a weight (or a coefficient). Q may be in either a symmetric or upper triangular form. The x term represents a vector having a range of binary values, 0 or 1, i.e. x∈{0, 1}. The diagonal terms of Q represent linear terms whilst the off-diagonal terms of Q represent quadratic terms. Accordingly, the objective problem is defined by the above equation.

A significant application of QUBO emerges from its equivalence to the Ising model, wherein the energy of a configuration of the Ising model is given by a Hamiltonian function defined by a first term and a second term as:

$$H ( σ ) = - {\sum }_{〈 i j 〉} {J}_{i j} {σ}_{i} {σ}_{j} - μ {\sum }_{j} {h}_{j} {σ}_{j}$$

The first term −Σ_{<ij>}Jᵢⱼσᵢσⱼ corresponds to an interaction (or coupling strength) Jᵢⱼ between a first site i and a second site j. The first site may have a first spin, σᵢ and the second site may have a second spin, σⱼ, each spin having a value of +1 or −1, i.e. σ∈{−1, 1}ⁿ. The notation <ij> indicates that the first site and the second site are nearest neighbours, wherein each pair of sites is counted once. The second term, −μΣⱼhⱼσⱼ represents an interaction between the system and an external bias hⱼ, for example a transverse magnetic field. The external bias is generated by the bias device 144. Therefore, hⱼ is a strength of the magnetic field interacting with the site j having a spin σⱼ. Importantly, interaction Jᵢⱼ and bias hⱼ are programmable parameters that may be adjusted. The Ising model may be translated into a QUBO problem, or vice versa, by defining xᵢ=(σⱼ+1)/2. Accordingly, the QUBO problem advantageously maps to the Ising model which, following the quantum annealing process, leads to a ground state solution corresponding to a minimised solution of the real world problem. Accordingly, the objective problem is implemented by the quantum computing unit as a Hamiltonian with adjustable parameters Jᵢⱼ and hⱼ. Importantly, a length of vector x corresponds to the number N of qubits required to represent the objective optimisation problem.

Accordingly, the QUBO framework may express a real world problem as an energy function which can be provided to the quantum computer. The variables identified in relation to the real world problem are mapped to the variables of the QUBO energy function. The QUBO energy function may be thought of as a matrix wherein each value in the matrix expresses the relationship between two different qubits in the quantum computer. For simplicity some embodiments herein may be described in terms of a problem expressed in a two-dimensional QUBO matrix. However, other embodiments may express problems in terms of three or more dimensions. Once the energy function has been input to the quantum computer, the physical properties of the quantum computer will cause the function to resolve to a minimum value landscape which may be output as an optimisation of the result.

The present disclosure relates to a computer-implemented method.

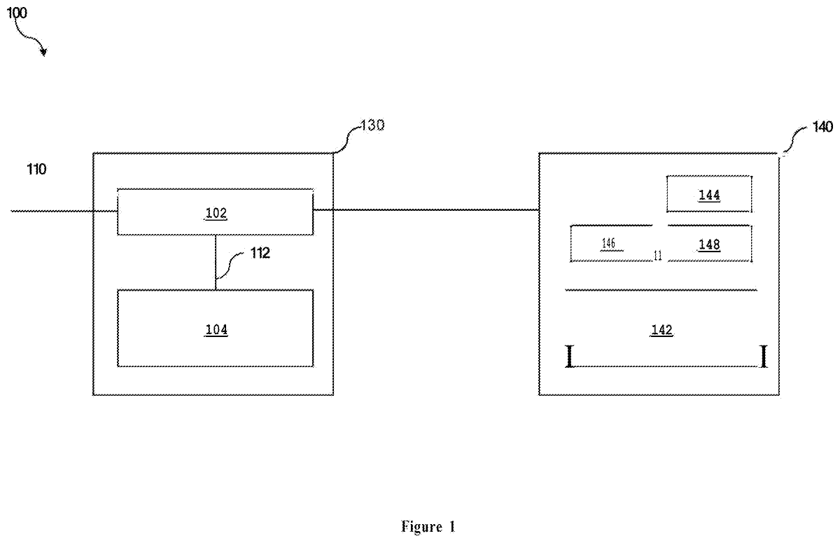

FIG. 1 shows a computing system 100 comprising a classical computer 130. The classical computer 130 comprises a CPU 102 coupled to a conventional memory 104 by means of a memory interface 112. Input information may be received by the CPU from an interface 110. Output information may be provided by the CPU to the interface 110. The classical computer 130 may further comprise additional classical computing elements as known in the art (not shown).

The classical computer is coupled to a distributed ledger 140. In the present example, the distributed ledger 140 is a Blockchain 140, although other types of distributed ledger known in the art may be envisaged. The Blockchain 140 comprises a decision making mechanism 142, a data transmitting means 144, a data receiving means 146, and a data storage means 148. The Blockchain 140 may further comprise additional Blockchain elements as known in the art (not shown).

The computing system may be coupled to a quantum computer. The quantum computer comprises a quantum computing unit and a quantum memory unit, a plurality of coupling devices, a bias device, and a state determination device. The quantum computing unit comprises a number N qubits. The qubits may be for example, superconducting flux devices having a circulating current. For example, the superconducting flux devices may comprise a loop of superconducting material interrupted by at least one Josephson junction, as is known in the art. Further qubit implementations may be envisaged. The quantum computing unit is configured to provide transactions to, and receive transactions from, the quantum memory unit by means of a memory interface. A “state” of the quantum computing unit corresponds to the respective state of all of the N qubits. An example state of a qubit is a 0 state. The 0 state may correspond to, for example, a clockwise current around the superconducting flux devices which may induce a downward magnetic field. A counter clockwise current around the superconducting flux devices may induce an upwards magnetic field which references a state 1. The state of the quantum computing unit may be described by a bit string having a length N. Thus, there are 2N possible configurations for the state of the quantum computing unit. The quantum computer may be quantum annealer. Other quantum computing models may be envisaged.

The coupling interaction of the Ising model may be implemented by coupling devices of a quantum computer which preferably couples (or entangles) a first qubit with a second qubit. The coupling device or devices may be, for example, a superconducting loop. The coupling between the first qubit and the second qubit is either ferromagnetic or anti-ferromagnetic as the qubits interact via their respective magnetic fluxes. A change in flux of the first qubit will affect the flux of the second qubit. If the coupling is ferromagnetic (i.e. Jᵢⱼ>0), it is energetically favourable for a change in flux of the first qubit to produce a similar change in the flux of the second qubit. Accordingly, a clockwise superconducting current in the first qubit will cause a clockwise superconducting current in the second qubit to be more energetically favourable than a counter-clockwise superconducting current. In this case, the first qubit and the second qubit will tend towards the 0 state. If the coupling is anti-ferromagnetic (i.e. Jᵢⱼ<0), it is energetically favourable for a change in the flux of the first qubit to cause an opposite effect in the flux of the second qubit. Accordingly, a clockwise superconducting current in the first qubit will cause a counter-clockwise superconducting current in the second qubit to be more energetically favourable than a clockwise superconducting current. In this case, the first qubit will tend towards the 0 state and the second qubit will tend towards the 1 state.

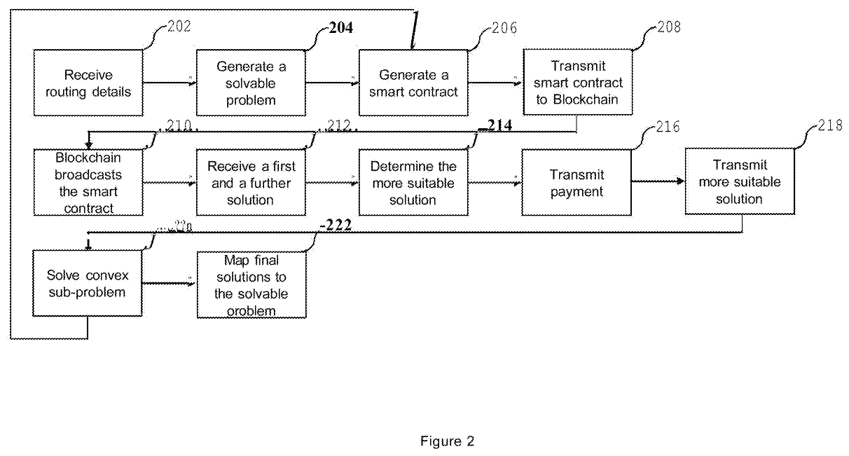

FIG. 2 shows a method 200 for optimizing vehicle routes using the computing system 100.

In a first step 202 of the method 200, routing details are received by the classical computer 130. The routing details correspond to a routing problem, such as the routing problem of S. Harwood, C. Gambella, D. Trenev, A. Simonetto, D. Bernal and D. Greenberg, “Formulating and Solving Routing Problems on Quantum Computers,” in IEEE Transactions on Quantum Engineering, vol. 2, pp. 1-17, 2021, Art no. 3100118. doi: 10.1109/TQE.2021.3049230. In particular, the routing problem relates to an optimal routing management of vehicles v of a set of vehicles V carrying a product p.

The routing problem may be formulated as a graph with a set of nodes N and directed edges E connecting nodes i of the set of nodes N. Each node i has a corresponding demand level qᵢ representative of a volume of the product p that is to be delivered (qᵢ<0) or picked up (qᵢ>0) to the node i. Each node i also has a corresponding time window [aᵢ, bᵢ] representative of an earliest time a; and a latest time bᵢ at which a vehicle v is allowed to reach a node i.

The graph further comprises a depot node d which represents both a departure and a destination node d. For example, the depot node d may represent a storage warehouse such that all vehicles v leave the depot node d at a maximum capacity Q. In the present example, the depot node d represents a starting depot node d, and a finishing depot node d, such that vehicles v start and finish at the depot node d.

Each vehicle v completes a route i, j of a set of allowable routes A, which corresponds to a journey between a first node i and a second node j. Each route i, j has a corresponding cost c_{i,j} and a travel time t_{i,j}. The cost c_{i,j} may be a distance between the first node i and the second node j. Each vehicle v is homogenous such that the maximum capacity Q, a travel speed, and a cost to operate of each vehicle v are the same.

The characteristics of the present example routing problem include travel times t_{i,j} that are substantially longer than the time windows [aᵢ, bᵢ]. Additionally, vehicles v are typically fully loaded (i.e. at maximum capacity Q) at supply points, such as the depot d and are fully unloaded at nodes i. Accordingly, the demand level qᵢ of each node i is equal to the maximum capacity Q. Furthermore, there are often multiple supply points and multiple receiver nodes i. The routes i, j are therefore restricted to being between supply points and demand points.

The objective of this routing problem is to minimize a cost of transportation, whilst meeting the demand and time window requirements of each of the nodes i.

At step 204 of the method 200, a solvable problem is generated by the classical computer 130 based on the routing problem. The solvable problem is generated such that a solution to the constrained optimization problem improves the efficiency of the routing of the fleet of vehicles. The solvable problem may be, for example, a mixed binary optimization (MBO) problem comprising discrete and/or continuous variables. The MBO problem may comprise inequality constraints that cannot be modelled as part of a QUBO problem. The solvable problem comprises a first, non-convex (e.g. QUBO), sub-problem and a second, convex constrained, sub-problem.

In the present example, a sequence-based formulation (SBF) with continuous time is implemented in step 204, based on the SBD with continuous time described in S. Harwood, C. Gambella, D. Trenev, A. Simonetto, D. Bernal and D. Greenberg, “Formulating and Solving Routing Problems on Quantum Computers,” in IEEE Transactions on Quantum Engineering, vol. 2, pp. 1-17, 2021, Art no. 3100118, doi: 10.1109/TQE.2021.3049230. The skilled person will understand that any formulation suitable for implementing the routing problem as a constrained optimization problem may be used.

The SBF with continuous time utilises continuous variables, rather than solely binary variables. In particular, the present example includes a continuous variable to track an arrival time of a vehicle v at each node i in a sequence of nodes. Each vehicle v may make a maximum number of stops P, wherein P−2 is the maximum number of nodes i excluding the starter depot node d and finisher depot node d. The maximum number of stops P may be based on a number of limitations, including but not limited to: capacity limitations; application requirements; or a number of receivers. Additionally, once a vehicle v has reached the finisher depot node d, it no longer travels to any further nodes i. Accordingly, (d, d) is a route from the starter depot node d to the finisher depot node d.

The SBF comprises a binary variable x_{v,p,i} having a value of I if a vehicle v visits a node i at a position p in its sequence of nodes, such that:

$${x}_{v , p , i} ∈ \{ 0 , 1 \} , ∀ ( v , p , i )$$

Additionally, the SBF with continuous time comprises a time of arrival variable sᵢ which represents a time at which a vehicle v arrives at a node rᵢ. A final arrival time variable sᵥ^{d} of each vehicle at the final depot node d is the duration of a journey v. The time of arrival variable si and the final arrival time variable sᵥ^{d} are both real variables collected as a time vector s.

The objective routing problem is therefore:

$${min}_{x , s} {\sum }_{v} {\sum }_{p < P} {\sum }_{( i , j ) ∈ A} {c}_{i , j} {x}_{v , p , i} {x}_{v , p + 1 , j}$$

The SBF (without the continuous time) comprises a plurality of constraints. The constraints include: a distribution constraint; a sequence constraint; an allowable route constraint; an end constraint; a starting node constraint; and a finishing node constraint.

The distribution constraint is configured to ensure that each node i is visited exactly once for all vehicles v and sequence positions except the depot node d. The distribution constraint is formulated as:

$${\sum }_{v ∈ V} {\sum }_{p = 1}^{P} {x}_{ν , p , i} = 1 , \qquad ∀ i ∈ N$$

The sequence constraint is configured to ensure that each vehicle v uses each position p in the sequence of nodes once. The sequence constraint is formulated as:

$${\sum }_{i ∈ N} {x}_{ν , p , i} = 1 , \qquad ∀ v ∈ V , p ∈ \{ 1 , … , P \}$$

The allowable route constraint is configured to ensure that each vehicle v travels along a route i, j of the set of allowable routes A. The allowable route constraint is formulated as:

$${x}_{v , p , i} {x}_{v , p + 1 , j} = 0 , ∀ v ∈ V ,$$

$$p ∈ \{ 1 , ... , P - 1 ) , ( i , j ) ∉ A$$

The end constraint is configured to ensure that once a vehicle v arrives at the depot d, it remains there and travels to no further nodes i. The end constraint is formulated as:

$${x}_{v , p , d} {x}_{v , p + 1 , j} = 0 , ∀ v ∈ V ,$$

$$p ∈ \{ 2 , ... , P - 1 ) , j \neq d$$

The starting node constraint is configured to ensure that every vehicle v in the set of vehicles V starts at the starting depot d, such that no nodes i precede the starting depot d. The starting node constraint comprises a first starting node constraint that is formulated as:

$${x}_{v , 1 , d} = 1 , ∀ v ∈ V$$

A second starting node constraint is associated with the starting node constraint. In particular, the second starting node constraint ensures that the starting node for each vehicle v is not a node i. The second starting node constraint is formulated as:

$${x}_{v , 1 , i} = 0 , ∀ v ∈ V , ∀ i ∈ N$$

A third starting node constraint is associated with the starting node constraint. The third starting node constraint is implied by the allowable route constraint and the first starting node constraint. The third starting node constraint is formulated as:

$${x}_{v , 2 , j} = 0 , ∀ v ∈ V , ( d , j ) ∉ A$$

The finishing node constraint is configured to ensure that every vehicle v in the set of vehicles V finishes at the finishing depot d, such that no further nodes i are visited. The final node constraint comprises a first finishing node constraint that is formulated as:

$${x}_{v , P , d} = 1 , ∀ v ∈ V$$

A second finishing node constraint is associated with the finishing node constraint. In particular, the second finishing node constraint ensures that the finishing node for each vehicle v is not a node i. The second finishing node constraint is formulated as:

$${x}_{v , P , i} = 0 , ∀ v ∈ V , ∀ i ∈ N$$

A third finishing node constraint is associated with the finishing node constraint. The third finishing node constraint is implied by the allowable route constraint and the first finishing node constraint. The third finishing node constraint is formulated as:

$${x}_{v , P - 1 , j} = 0 , ∀ v ∈ V , ( j , d ) ∉ A$$

In addition to the SBF constraints, the SBF with continuous time comprises additional time constraints, including: a time window constraint; a time of arrival constraint; and a finishing time constraint.

The time window constraint is configured to ensure that the time of arrival sᵢ is allowable. In particular, that the time of arrival si is within the time window [aᵢ, bᵢ] of a node i. The time window constraint is formulated as:

$${a}_{i} \leq {s}_{i} \leq {b}_{i} , ∀ i ∈ N$$

The time of arrival constraint is configured to ensure that the time of arrival sⱼ at a second node j is greater than or equal to the arrival time si at a first node i plus the travel time t_{i,j} between the first node i and the second node j. The time of arrival constraint is formulated as:

$${s}_{j} \geq {\sum }_{v ∈ V} {\sum }_{p < P} {\sum }_{i : ( i , j ) ∈ A} ( {s}_{i} + {t}_{i , j} ) {x}_{v , p , i} {x}_{v , p + 1 , j} , ∀ i ∈ N$$

The finishing time constraint is configured to ensure that the final arrival time variable sᵥ^{d} of a vehicle v at the final depot node d is greater than or equal to the time of arrival j at the second node j plus the travel time t_{j,d} between the second node j and the final depot node d. The finish time constraint is formulated as:

$${s}_{v}^{d} \geq {\sum }_{p < P} {\sum }_{j : ( j , d ) ∈ A} ( {s}_{j} + {t}_{j , d} ) {x}_{v , p , j} {x}_{v , p + 1 , d} , ∀ v ∈ V$$

Accordingly, the SBF with continuous time is a mixed binary optimization (MBO) problem comprising both binary variables and continuous decision variables. In particular, the binary variable is x_{v,p,i} (and the continuous decision variables are the arrival variable si and the final arrival time variable sᵥ^{d}. The presence of the time of arrival constraint and the finishing time constraint makes the continuous relaxation of the routing problem non-convex.

The non-convex sub-problem is configured to solve the objective routing problem with a fixed time vector s, such that the QUBO sub-problem is solved for the binary variable is x_{v,p,j}. As discussed above, the standard form for QUBO problems is:

$${min}_{x} {x}^{T} Mx + c$$

$$s . t . x ϵ {\{ 0 , 1 \}}^{n}$$

Wherein M is an n by n real matrix and c is a scalar offset corresponding to a penalty.

In order to construct a matrix M such that the QUBO standard form is representative of the routing problem, the linear equality constraints may be expressed as Ax=b. The skilled person will understand that the linear equality constraints include: the distribution constraint, the sequence constraint, the time of arrival constraint, and the finish time constraint. The bilinear equality allowable route and end constraints are represented as a penalty term:

$$w : x \to {‖ Ax - b ‖}^{2} + {\sum }_{v} {\sum }_{p < P} {\sum }_{( i , j ) ∉ A} {x}_{v , p , i} {x}_{v , p + 1 , j} + {\sum }_{v} {{\sum }_{p = 2}}^{P - 1} {\sum }_{j : j \neq d} {x}_{v , p , d} {x}_{v , p + 1 , j}$$

A penalty reformulation of the objective routing problem with the fixed time vector s is:

$${min}_{x} {\sum }_{v} {\sum }_{p < P} {\sum }_{( i , j ) ∈ A} {c}_{i , j} {x}_{v , p , i} {x}_{v , p + 1 , j} + ρ w ( x )$$

Wherein ρ is a penalty parameter configured to prevent a decrease in the objective routing problem by moving the solution to an infeasible point.

The convex constrained sub-problem requires an additional step 204B, wherein the classical computer 130 determines a convex approximation of the non-convex constraints.

In particular, step 204B includes employing sequential convex programming by introducing a continuous variable u_{v,p,i}∈[0,1] for each three-indexed binary variable x_{v,p,i}, and setting u_{v,p,i}=x_{v,p,i}.

Accordingly, the time of arrival constraint and the finishing time constraint are:

$${s}_{j} \geq {\sum }_{v ∈ V} {\sum }_{p < P} {\sum }_{i : ( i , j ) ∈ A} ( {s}_{i} + {t}_{i , j} ) {u}_{v , p , i} {u}_{v , p + 1 , j} , ∀ i ∈ N$$

$${s}_{v}^{d} \geq {\sum }_{p < P} {\sum }_{j : ( j , d ) ∈ A} ( {s}_{j} + {t}_{j , d} ) {u}_{v , p , j} {u}_{v , p + 1 , d} , ∀ v ∈ V$$

Step 204B advantageously provides that the time of arrival constraint and the finishing time constraint may be written as a non-convex function g that allows the continuous problem to reach a solution through an alternating direction method of multipliers (ADMM) method using a known sequential convex programming. In particular, the non-convex function g may be written as:

$$g ( s , u ) \leq 0$$

Whilst g is not convex, the sequential convex programming approach allows the continuous problems of the ADMM to converge to a local stationary point.

The convex constrain sub-problem is:

$${min}_{s} {\sum }_{v} {\sum }_{p < P} {\sum }_{( i , j ) ∈ A} {c}_{i , j} {u}_{v , p , i} {u}_{v , p + 1 , j}$$

The skilled person will understand that in cases where all functions are convex, step 204B is not required.

In some cases, the method 200 may instead start with a step 205, wherein the classical computer 130 receives a constrained optimization problem. The constrained optimization problem may have been generated externally. For example, a third party may generate a constrained optimization problem, and submit it to the present computing system 100 for solving.

In the present example, the classical computer 130 solves the solvable problem following an alternating direction method of multipliers (ADMM) method. In this ADMM method, the binary variable x_{v,p,i} and the second variable s are alternatively solved by fixing the other variable. For example, in a first iteration of the method 200, the binary variable x_{v,p,i} is solved while holding the second variable s fixed and in a second iteration, the second variable s is solved while holding the binary variable x_{v,p,i} fixed. By performing iterations of alternating steps of updates on subset of variables, computational complexity may be reduced when compared to other methods for solving constrained optimization problems, such as augmented Lagrangian methods.

In order to solve the solvable problem following the ADMM method, a first solution to the QUBO sub-problem is determined. At step 206, the classical computer 130 generates a smart contract. The smart contract corresponds to the QUBO sub-problem.

The skilled person will understand that a smart contract is a self-executing contract comprising terms of agreement between a first party and a second party. A smart contract is implemented via code and exists across a distributed network, such as the Blockchain 140 of the present invention. The smart contract is configured to automatically execute, control or document legally relevant events and actions according to the terms of a contract or an agreement. Accordingly, in this step 206, the classical computer 130 generates code corresponding to the QUBO sub-problem. Additionally, the smart contacts each comprise a pay-out representative of a fee configured to be distributed following completion of the smart contract.

At step 208, the classical computer 130 transmits the smart contract to a distributed ledger. In particular, the classical computer 130 transmits the smart contracts to the Blockchain 140. For example, the classical computer 130 may deploy the smart contract on the Blockchain 140 by sending a transaction from a “wallet” for the Blockchain 140, the transaction comprising the code corresponding to the smart contract (and by proxy, the QUBO problem). The skilled person will understand that the term “wallet” means a device which stores public and/or private keys for transactions occurring on distributed ledgers, such as the Blockchain in the present invention.

At step 210, the distributed ledger broadcasts the smart contract to a plurality of solvers.

One or more of the solvers may correspond to a third party. There may be a plurality of third parties, each corresponding to one or more solvers. Alternatively, the solvers may be devices associated with the computing system 100, such as the previously described quantum computer. A solver is an entity that provides a service of solving the sub-problem corresponding to the smart contract. There is no restriction on the means by which a solver solves the sub-problem. For example, a solver may solve the QUBO problem by expressing the QUBO problem as an energy function to be provided to a quantum computer (in particular a quantum annealer). Alternatively, the solver may solve the QUBO problem via classical means, such as via a digital annealer, or any other classical solver. The skilled person will understand that the means by which a solver solves the QUBO problem is not pertinent to the scope of the present invention.

At step 212, the Blockchain 140 receives, from a first solver of the plurality of solvers; a first solution associated with the smart contract. Additionally, at step 214, the Blockchain 140 receives, from a further first solver of the plurality of solvers; a further first solution associated with the smart contract. The further solutions may be received simultaneously, or at different times to, the first solution.

The solutions to the QUBO sub-problems each comprise a vector having a range of binary values, 0 or 1, corresponding to the QUBO problem. In other words, a solution is a string of bits. Importantly, this string of bits does not provide enough information to recover the original QUBO problem, and as such, if a third party intercepts a solution, they will be unable to determine the QUBO problem. In order to further increase the security of the present invention, the rows and columns of the QUBO problem may be switched such that the difficulty in recovering the QUBO problem is further increased.

At step 214, the Blockchain 140 determines, using the decision mechanism, the solution of the first solution and the further first solution that is more suitable. In particular, the decision mechanism determines the more suitable solution by determining which solution is the lowest energy solution. The lowest energy solution is determined by applying the respective solution to the QUBO problem and comparing each resultant energy solution and selecting the lowest resultant energy solution.

In some cases, the first solution may be the same as the further first solution. In such cases, a further metric may be used to determine which solution is more suitable. An example further metric is time of arrival. In this case, if the first solution is the same as the further solution but is received by the Blockchain 140 first, the Blockchain 140 will determine that the first solution is the more suitable solution.

Optionally, the Blockchain 140 may apply a merit function to each of the received solutions. The merit function is configured to determine a trade-off between feasibility and optimality.

At step 216, the Blockchain 140 transmits a payment associated with the first smart contract to the solver of the more suitable first solution, and a payment associated with the second smart contract to the solver of the more suitable second solution.

At step 218, the Blockchain 140 transmits the more suitable solution to the QUBO sub-problem to the classical computer 130.

At step 220, the classical computer 130 solves the convex sub-problem using the solution to the QUBO sub-problem received in step 218, thereby producing a time vector solution. In the present case, the convex sub-problem is a convex constrained sub-problem. Accordingly, this convex sub-problem is configured to be solved on a classical solver, such Gurobi or CPlex. The convex sub-problem is configured to solve the objective routing problem with a fixed binary variable x_{v,p,i}, such that the convex sub-problem is solved for the time vector s. The time of arrival constraint and the finishing time constraint are of the form determined in step 204B, such that the continuous variable u_{v,p,i} takes the place of the binary variable x_{v,p,i}.

The skilled person will understand that in cases wherein the objective problem may be composed of solely non-convex sub-problems, the second sub-problem may instead also be a QUBO sub-problem. In this case, steps 206 to 218 are replicated for the second sub-problem.

Steps 206 to 220 are repeated using the second solution determined in step 218 as a new fixed time vector for solving the QUBO sub-problem. Steps 206 to 220 are repeated until a threshold is met.

The threshold may be an iteration threshold such that steps 206 to 220 are repeated until a threshold number of iterations is met. The threshold number of iterations may be, for example, 100 iterations. Accordingly, a local minimum solution may be reached.

Alternatively, the threshold may be a plateau threshold, wherein if a solution to the new QUBO sub-problem and/or a solution to the new convex sub-problem is the same as the respective solutions for the iteration of the method 200, the plateau threshold is met. Alternatively, if a difference between a current iteration solution and a previous iteration solution is less than a difference

At step 222, the classical computer 130 maps the respective solutions of a final iteration into the respective sub-problems, such that an optimized routing solution is reached.

In an alternative transaction settlement optimization method for solving a transaction settlement optimization problem, transaction details are received. The transaction details may include details of trades occurring between party x and party y. For example, a trade may be party x buying z shares of party y for an amount z′ of a currency.

The objective of this transaction settlement optimization method is to settle as many transactions as possible or to maximize the total value of settled transactions. For example, the objective may be to maximize a weighted sum of settled transactions, wherein the weight is based on a total monetary value of a respective transaction. In the case that the objective is to settle as many transactions as possible, all transactions may instead be equally weighted.

Constraints for the transaction settlement optimization problem include legal constraints, security constraints associated with party x, currency constraints associated with party x, credit constraints associated with party x, and collateral constraints associated with party x. The skilled person will understand that any constraints associated with the transaction settlement optimization problem may be implemented.

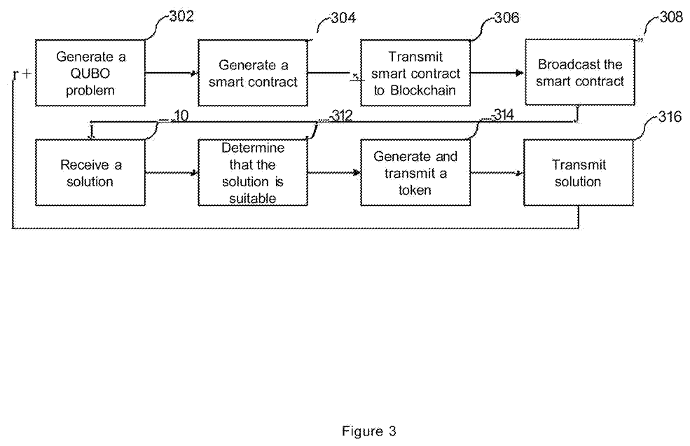

FIG. 3 shows a method 300 for generating a cryptocurrency token using the computing system 100.

At step 302, a solvable problem is generated by the classical computer 130. The solvable problem may be a QUBO problem or sub-problem generated following the method 200. The solvable problem is therefore a complex problem suitable for being solved by a quantum computer such as a quantum annealer. The skilled person will appreciate that the solvable problem may be any problem suitable for solving on a quantum computer such as a quantum annealer.

At step 304, the classical computer 130 generates a smart contract. The smart contract corresponds to the QUBO problem. The skilled person will understand that a smart contract is a self-executing contract comprising terms of agreement between a first party and a second party. A smart contract is implemented via code and exists across a distributed network, such as the Blockchain 140 of the present invention. The smart contract is configured to automatically execute, control or document legally relevant events and actions according to the terms of a contract or an agreement. Accordingly, in this step 304, the classical computer 130 generates code corresponding to the QUBO problem.

At step 306, the classical computer 130 transmits the smart contract comprising the QUBO problem to a distributed ledger. In particular, the classical computer 130 transmits the smart contract to the Blockchain 140. For example, the classical computer 130 may deploy the QUBO problem on the Blockchain 140 by sending a transaction from a “wallet” for the Blockchain 140, the transaction comprising the code corresponding to the QUBO problem. The skilled person will understand that the term “wallet” means a device which stores public and/or private keys for transactions occurring on distributed ledgers, such as the Blockchain 140 in the present invention. The Blockchain 140 maintains, and broadcasts, a series of blocks corresponding to previously solved QUBO problems, wherein an immediately preceding block comprises a solution to an immediately preceding QUBO problem.

At step 308, the Blockchain 140 broadcasts the smart contract to a plurality of solvers. One or more of the solvers may correspond to a third party. There may be a plurality of third parties, each corresponding to one or more solvers.

Alternatively, the solvers may be devices associated with the computing system 100, such as the previously described quantum computer. A solver is an entity that provides a service of solving the QUBO problem corresponding to the smart contract. There is no restriction on the means by which a solver solves the sub-problem. For example, a solver may solve the QUBO problem by expressing the QUBO problem as an energy function to be provided to a quantum computer (in particular a quantum annealer). Alternatively, the solver may solve the QUBO problem via classical means, such as via a digital annealer, or any other classical solver. The skilled person will understand that the means by which a solver solves the QUBO problem is not pertinent to the scope of the present invention. Advantageously, the present method provides a secure means for generating a cryptocurrency token because an attack intercepting a solution to the QUBO problem will not be able to deduce the QUBO problem from the solution.

At step 310, the Blockchain 140 receives within a threshold time limit of step 306, from a solver of the plurality of solvers; a solution associated with the smart contract. The solution to the QUBO problem comprises a vector having a range of binary values, 0 or 1, corresponding to the QUBO problem. In other words, a solution is a string of bits. Importantly, this string of bits does not provide enough information to recover the original QUBO problem, and as such, if a third party intercepts a solution, they will be unable to determine the QUBO problem. In order to further increase the security of the present invention, the rows and columns of the QUBO problem may be switched such that the difficulty in recovering the QUBO problem is further increased. The solver may use the solution as a proof of a successful cryptocurrency token generation. In some embodiments the energy required to solve a QUBO problem may be less than the energy required to reach a solution to the Bitcoin hashing problem using existing techniques. Accordingly, the present method advantageously provides a cryptocurrency generation method which is less energy-intensive than Bitcoin mining, which in turn reduces the impact on the environment.

Some embodiments may reduce the environmental impact of cryptocurrency mining by as the processing power used for each bid for a line of the blockchain is also used to solve a real world problem which has been encoded into a QUBO problem to be solved by a quantum computer. In other words, rather than wasting energy to perform a known calculation in order to bid for the line of the blockchain, embodiments perform a process which may output a secondary useful solution as part of the bidding process.

At step 312, the Blockchain 140 determines that the solution is a suitable solution of the QUBO problem. The Blockchain determines that the solution is suitable by applying the solution to the QUBO problem.

At step 314, the Blockchain 140 generates and transmits a cryptocurrency token to the solver, such that the solver possesses the cryptocurrency token generated in response to their solution. The Blockchain 140 also generates a block associated with the solution and distributes the block to the Blockchain network such that other parties of the Blockchain 140 may validate the solution, and update their respective ledgers.

At step 316, the Blockchain 140 transmits the solution to the classical computer 130.

Steps 302 to 316 are repeated, wherein at step 302 a new QUBO problem is generated. In alternative embodiments, a plurality of QUBO problems are generated at step 302, and a new QUBO problem from the plurality of QUBO problems is selected for each new block of the Blockchain.

Some embodiments may assign computer processing tasks to recipient processors, for example, but not limited to CPUs, GPUs, DSPs, GP-GPUs, quantum processor and/or processors optimised for artificial intelligence tasks. In such embodiments, the processors are the recipients and the processing tasks are the opportunities. In such embodiments, in for example, a complex cloud computing infrastructure a large number of tasks, of differing types, requiring execution may be received and a large number of processors may be housed within the cloud computing infrastructure.

The description provided herein may be directed to specific implementations. It should be understood that the discussion provided herein is provided for the purpose of enabling a person with ordinary skill in the art to make and use any subject matter defined herein by the subject matter of the claims.

It should be intended that the subject matter of the claims not be limited to the implementations and illustrations provided herein, but include modified forms of those implementations including portions of implementations and combinations of elements of different implementations in accordance with the claims. It should be appreciated that in the development of any such implementation, as in any engineering or design project, numerous implementation-specific decisions should be made to achieve a developers' specific goals, such as compliance with system-related and business related constraints, which may vary from one implementation to another. Moreover, it should be appreciated that such a development effort may be complex and time consuming, but would nevertheless be a routine undertaking of design, fabrication, and manufacture for those of ordinary skill having benefit of this disclosure.

Reference has been made in detail to various implementations, examples of which are illustrated in the accompanying drawings and figures. In the detailed description, numerous specific details are set forth to provide a thorough understanding of the disclosure provided herein. However, the disclosure provided herein may be practiced without these specific details. In some other instances, well-known methods, procedures, components, circuits, and networks have not been described in detail so as not to unnecessarily obscure details of the embodiments.

It should also be understood that, although the terms first, second, etc. may be used herein to describe various elements, these elements should not be limited by these terms. These terms are only used to distinguish one element from another. For example, a first element could be termed a second element, and, similarly, a second element could be termed a first element. The first element and the second element are both elements, respectively, but they are not to be considered the same element.

The terminology used in the description of the disclosure provided herein is for the purpose of describing particular implementations and is not intended to limit the disclosure provided herein. As used in the description of the disclosure provided herein and appended claims, the singular forms “a.” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

While the foregoing is directed to implementations of various techniques described herein, other and further implementations may be devised in accordance with the disclosure herein, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A non-convex sub-problem solving method comprising the steps:
determining, by a classical computer, the non-convex sub-problem based on a constrained optimization problem;
generating, by the classical computer, a smart contract corresponding to the non-convex sub-problem;
transmitting, by the classical computer, the smart contract to a distributed ledger;
broadcasting, by the distributed ledger, the smart contract to a plurality of solvers;
receiving, at the distributed ledger, a first solution to the non-convex sub-problem from a first solver;
receiving, at the distributed ledger, a further solution to the non-convex sub-problem from a second solver;
determining, by a decision mechanism of the distributed ledger, the solution of the first solution and the further solution that is more suitable;
transmitting, by the distributed ledger to the solver of the more suitable solution, a payment associated with the smart contract;
transmitting, by the distributed ledger to the classical computer, the more suitable solution.

2. The method of claim 1, wherein the non-convex sub-problem is a quadratic unconstrained binary optimization (QUBO) sub-problem.

3. The method of claim 1, wherein the first and further solutions are each binary strings.

4. The method of claim 1, wherein the suitability of a solution is dependent on an energy of the solution.

5. The method of claim 4, wherein the more suitable solution is the solution providing the lowest energy.

6. The method of claim 4, wherein determining the energy of the solution of a QUBO sub-problem comprises applying the solution to the QUBO sub-problem, thereby producing an energy scalar.

7. The method of claim 4, wherein the suitability of the solution is further dependent on a time of arrival of the solution.

8. A routing optimization computer implemented method comprising the steps:
(a) determining, by the classical computer, a non-convex sub-problem and a convex sub-problem of a constrained optimization problem, the constrained optimization problem comprising:
a binary variable indicative of a vehicle visiting a plurality of nodes; and
a continuous variable representative of a time at which the vehicle arrives at each of the plurality of nodes;
wherein the continuous variable is fixed for the non-convex sub-problem and the binary variable is fixed for the convex sub-problem;
(b) generating, by the classical computer, a smart contract corresponding to the non-convex sub-problem;
(c) transmitting, by the classical computer, the smart contract to a distributed ledger;
(d) broadcasting, by the distributed ledger, the smart contract to a plurality of solvers;
(e) receiving, at the distributed ledger, a first binary solution to the non-convex sub-problem from a first solver;
(f) receiving, at the distributed ledger, a further binary solution to the non-convex sub-problem from a second solver;
(g) determining, by a decision mechanism of the distributed ledger, a more suitable solution of the first binary solution and the further binary solution;
(h) transmitting, by the distributed ledger to the solver of the more suitable binary solution, a payment associated with the smart contract;
(i) transmitting, by the distributed ledger to the classical computer, the more suitable binary solution;
(j) determining, by the classical computer, a time solution to the convex sub-problem using the more suitable binary solution as the binary variable;
(k) repeating steps (b) to (c), using the time solution as the continuous variable, until a threshold is met; and
(l) mapping the binary solution and the time solution to the constrained optimization problem, thereby providing an optimized routing.

9. The method of claim 8, wherein the non-convex sub-problem is a quadratic unconstrained binary optimization (QUBO) sub-problem.

10. The method of claim 8, wherein the constrained optimization problem is solved according to an alternating direction method of multipliers (ADMM) method.

11. The method of claim 8, wherein time solution is determined according to a sequential convex programming method.

12. The method of claim 8, further comprising determining the constrained optimization based on a set of routing details, wherein the constrained optimization problem comprises a plurality of constraints.

13. The method of claim 12, wherein the plurality of constraints comprises:
a distribution constraint;
a sequence constraint;
an allowable route constraint;
an end constraint;
a starting node constraint;
a finishing node constraint;
a time window constraint;
a time of arrival constraint; and
a finishing time constraint.

14. The method of claim 8, wherein the threshold is an iteration threshold.

15. The method of claim 8, wherein the threshold is a solution plateau threshold.

16. The method of claim 8, wherein the suitability of a solution is dependent on an energy of the solution; and optionally a time of arrival of the solution.

17. The method of claim 16, wherein determining the energy of the solution of a QUBO sub-problem comprises applying the solution to the QUBO sub-problem, thereby producing an energy scalar.

18. The method of claim 1, wherein the distributed ledger is a blockchain.
